(19) United States
(12) Patent Application Publication
(10) Pub. No.: US 2025/0089608 A1
(43) Pub. Date: Mar. 20, 2025

(54) Novel String Trimmer Support

(71) Applicant: Gregory Wade Hoffmann, Sumter, SC (US)

(72) Inventor: Gregory Wade Hoffmann, Sumter, SC (US)

(21) Appl. No.: 18/827,678

(22) Filed: Sep. 7, 2024

Related U.S. Application Data
(63) Continuation-in-part of application No. 17/521,822, filed on Nov. 8, 2021, now abandoned.

(51) Int. Cl. A01D 34/84; A01D 34/416; A01D 101/00

(52) U.S. Cl. CPC A01D 34/84; A01D 34/416; A01D 2101/00

(57) ABSTRACT

The present invention consists of a novel design of a lightweight string trimmer support intended to be positioned above the cutter head in a parallel plane to the plane of the rotating string generally consisting of an integral attachment device sized to fit string trimmer shafts both straight and curved and fastening to an angled or curved support arm to the string trimmer shaft with a wheel assembly connected to the opposite end of the attachment device configured so that the wheel is closely parallel to the plane of the string motion. The attachment device is design to allow for adjustments along the trimmer shaft for allow for proper positioning and well as allow for rotation adjustment to allow the wheel to be positioned at a slight planer angle to the string rotation plane to retard to the pull forces caused by the string trimmer impacting the surface at the string end.

### CROSS REFERENCE TO RELATED APPLICATIONS

This non-provisional utility application is a Continuation in Part of application Ser. No. 17/521,822 with a filing date of Nov. 8, 2021.

### Statement Regarding Prior Disclosures by the Inventor or a Joint Inventor

This non-provisional utility application is a Continuation in Part of application Ser. No. 17/521,822 with a filing date of Nov. 8, 2021. The application was published on May 11, 2023 with document number 20230144921 A1. The product disclosed in the CIP application is currently being marketed via the internet at https://edgitec.com.

### STATEMENT REGARDING FEDERALLY SPONSORED RESEARCH OR DEVELOPMENT

This invention was not made by an agency of the United States Government nor under a contract with an agency of the United States Government.

### THE NAME OF THE PARTIES TO JOINT RESEARCH AGREEMENT

Not Applicable.

### INCORPORATION BY REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### BACKGROUND OF THE INVENTION

### Field of the Invention

String trimmers are a useful tool in ground/vegetation management and beatification. However, string trimmers can be difficult to control when used for application/operations other than that of an open field horizontal/parallel cutting (typical trimming) application. When used in vertical trimming applications, such as edging, the weight of the trimmer and the reactionary forces the string imparts to the trimmers can make operating them difficult to control and produce desired results.

When string trimmers are used near/against vertical surfaces (or those perpendicular/non to the plane of the string rotation) in a horizontal application, maintaining proper distance so as to not damage the vertical surface can be difficult as well for the same reasons mentioned above.

The present invention relates to a novel support system for string trimmers. More particularly, the invention relates to a string trimmer support system capable of supporting and positioning string trimmer cutting systems in various positions.

### Description of Related Art

U.S. Pat. No. 11,147,210 B2, String Trimmer Attachment Assembly (Landry) discloses an attachment to a string trimmer. Although there are similarities between the Landry patent and the invention disclosed in this application, there are also distinct differences between the two inventions.

The present invention attaches to the string trimmer in a different method than the Landry invention. The Landry invention utilizes two rollers versus one roller of the present invention. The Landry invention places the rollers directly below the trimming head of the string trimmer, thus placing the rollers in close proximity to the trimming line thus presenting the risk of entanglement of the trimming line with the rollers. The present invention is design to place the roller at a distance from the trimming head and trimming line. One embodiment of the present invention utilizes hinges to position the roller along side the shaft of the string trimmer when it is not in use. The Landry invention does not have this feature.

### BRIEF SUMMARY OF THE INVENTION

The present invention consists of a novel design of a lightweight string trimmer support intended to be positioned above the cutter head in a parallel plane to the plane of the rotating string generally consisting of an integral attachment apparatus sized to fit both straight and curved string trimmer shafts and fastening an angled or curved support arm to the string trimmer shaft with a wheel assembly connected to the opposite end of the attachment apparatus configured so that the wheel is closely parallel to the plane of the string motion. The attachment device is design to allow for adjustments along the trimmer shaft for allow for proper positioning and well as allow for rotation adjustment to allow the wheel to be positioned at a slight planer angle to the string rotation plane to retard to the pull forces caused by the string trimmer impacting the surface at the string end.

### BRIEF DESCRIPTION OF THE SEVERAL VIEWS OF THE DRAWING

FIG. 1A depicts an exploded perspective view of one example of a string trimmer support according to various embodiments of the present invention.

FIG. 1B depicts an assembled perspective view of one example of a string trimmer support according to various embodiments of the present invention.

FIG. 2 shows a side view perspective of one example of a string trimmer support attached to a string trimmer being used to trim along a vertical surface.

FIG. 3 depicts a top view perspective of one example of the clamping apparatus according to various embodiments described herein.

FIG. 4 illustrates a side view perspective of one example of the assembled invention attached to a string trimmer and being used to edge along a horizonal surface.

FIG. 5A illustrates a side view perspective of one example of the hinged apparatus according to various embodiments described herein.

FIG. 5B illustrates a side view perspective of one example of the hinged apparatus according to various embodiments described herein.

FIG. 6A illustrates a side view sketch of one example of a string trimmer support according to various embodiments described herein.

FIG. 6B illustrates a top (overhead) view sketch of one example of a string trimmer support according to various embodiments described herein.

FIG. 7A illustrates a side view perspective sketch of one example of a string trimmer support for straight shaft string trimmers according to various embodiments described herein.

FIG. 7B illustrates a side view perspective sketch of one example of a string trimmer support for curved shaft string trimmers according to various embodiments described herein.

FIG. 8 illustrates a side view perspective sketch of one example of the assembled invention being used to trim around a vertical surface.

FIG. 9 illustrates a top view perspective sketch of one embodiment of the assembled invention configuration showing the wheel angle for torsion control relating to various embodiments described herein.

FIG. 10 illustrates a top view perspective sketch of one example of the assembled invention configuration showing the support arm offset relating to various embodiments described herein.

FIG. 11A illustrates a top view perspectives sketch of one examples of the assembled invention configuration showing multi wheel options relating to various embodiments described herein.

FIG. 11B illustrates a top view perspectives sketch of one examples of the assembled invention configuration showing multi wheel options relating to various embodiments described herein.

FIG. 12 illustrates a side view perspective sketch of one example of the assembled invention in used for shrubbery bed edging with the roller on a horizontal surface.

FIG. 13 illustrates a side view perspective sketch of one example of the assembled invention configuration showing adjustment relating to changing attach angle of the string rotation relating to various embodiments described herein.

FIG. 14 illustrates a side view perspective sketch of one examples of the assembled invention configuration showing adjustment relating to changing the support arm angle relative to the string rotation relating to various embodiments described herein.

FIG. 15 illustrates a side view perspective sketch of one example of the assembled invention configuration showing a support arm bumper pad option relating to various embodiments described herein.

FIG. 16A illustrates a top view perspective of one example of the assembled invention configuration showing clamping option for the support arm on the side of the string trimmer shaft option relating to various embodiments described herein.

FIG. 16B illustrates a side view perspective of one example of the assembled invention configuration showing clamping option for the support arm on the side of the string trimmer shaft option relating to various embodiments described herein.

FIG. 17A illustrates a top view perspective of one example of the assembled invention configuration showing clamping option for the split support arm on the both sides of the string trimmer shaft option relating to various embodiments described herein.

FIG. 17B illustrates a side view perspective of one example of the assembled invention configuration showing clamping option for the split support arm on the both sides of the string trimmer shaft option relating to various embodiments described herein.

FIG. 18A illustrates a top view perspective of one example of the assembled invention configuration showing clamping option with retraction hinge option for the split support arm on the string trimmer shaft option relating to various embodiments described herein.

FIG. 18B illustrates a side view perspective of one example of the assembled invention configuration showing clamping option with retraction hinge option for the split support arm on the string trimmer shaft option relating to various embodiments described herein.

FIG. 19A illustrates a top view perspective of one example of a welded (integral part to the string trimmer shaft) receiving bracket option relating to various embodiments described herein.

FIG. 19B illustrates a side view perspective of one example of a welded (integral part to the string trimmer shaft) receiving bracket option relating to various embodiments described herein.

FIG. 20 illustrates a top view perspective of one example of an adjustable support arm option relating to various embodiments described herein.

### DETAILED DESCRIPTION OF THE INVENTION

The terminology used herein is for the purpose of describing particular embodiments only and not intended to be limiting of the invention. As used herein, the term and/or includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises”, and/or “comprising,” when used in this specification, specify the presence of stated features, steps, operations, elements, and/or components, but do not preclude the presence or addition of one or more other features, steps, operations, elements, and/or components and/or groups thereof.

In describing the invention, it is understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of individual steps in an unnecessary fashion. Nevertheless, the specifications and claims should be read with the understanding that such combinations are entirely withing the scope of the invention and claims.

New string trimmer support devices, apparatuses, and methods for operating string trimmers are discussed herein. In the following description, for the purposes of explanation, numerous specific details are set forth in order to provide a thorough understating of the present invention. It will be evident, however, to one skill in the art that the present invention may be practiced without these specific details.

The present disclosure is to be considered as an exemplification of the invention and is not intended to limit the invention to the specific embodiments illustrated by the figures or descriptions below.

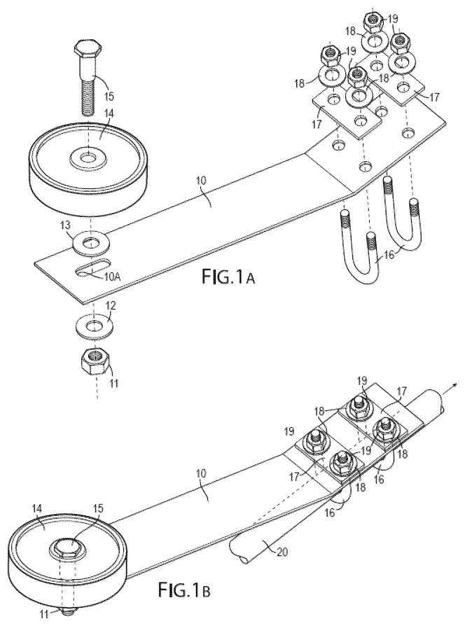

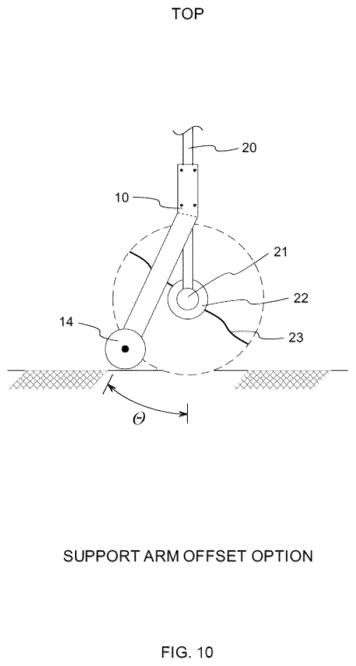

FIG. 1A depicts an exploded perspective view of the basic elements that comprise a String Trimmer Support device (the “device”) according to various embodiments of the present invention. The device consists of an angled support arm 10, which is configured to accept a clamping or other securing device to a string trimmer shaft 20 (FIGS. 1B, 10A, 10B). While preferred material for support arm 10 is aluminum, other metals, metal alloys, plastics and other sufficiently rigid and appropriately flexible materials could be used. The angled support arm 10 may be solid or porous depending on material of choice. Structural holes can be included along the support arm 10 to reduce its weight while maintaining proper rigidity and flexibility. While a flexible/semi-rigid support arm 10 offers better control, stiffening/stiffeners such as folds, bends, creases in the angled support arm 10 can be added as desired.

The angled support arm 10 may be of various lengths. With the basic device the longer section 10B of the support arm 10 is ten to eighteen inches in length with the shorter section 10C of the support arm 10 is four to ten inches in length with an angle between sections 10B and 10C of 140 to 170 degrees. The length of the angled support arm will be determinative of the placement of the device on the string trimmer shaft 20 as the wheel 14 at this distal end of the support arm 10 must be able to roll on the ground. The angled support arm 10 can be of various cross-section configurations both solid and hollow such as rectangular solid plate, square/rectangular tubing or round/oval tubing. The angled support arm 10 may be constructed of a single piece of metal.

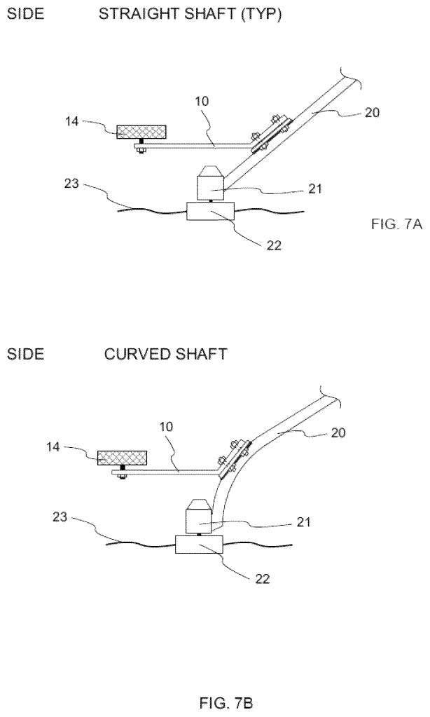

The clamping apparatus is configured with a clamping apparatus bracket (“U-bolt”) 16, clamping apparatus plate 17, clamping apparatus washers 18 and clamping apparatus nuts 19. The clamping device is configured to secure the support arm 10 to the string trimmer shaft 20. While typical threaded nuts are shown for the clamping apparatus nuts 19 sized for the clamping apparatus bracket (“U-bolt”) 16, these can be replaced with wing nuts, knobs, rotating knobs, lever style wing nuts, self-locking nuts, double nutting, cap nuts, or other threaded device. For illustrative purposes, a threading “U-bolt” type of clamping apparatus is shown: however, other types of clamping devices could be equally effective in securing the support arm 10 to the string trimmer shaft 20 such as quick release clamps, toggle clamps, quick lever clamp, seat post clamp—all types, saddle clamp, telescoping tube clamp, split pipe clamps, set screw clamps, set screws with integral bracket, etc. The functional diameter (interior diameter—ID) of the clamping device can vary to fit the functional diameter (exterior diameter—OD) of the string trimmer shaft 20. The clamping device/support arm 10 configuration can fit both straight and curved string trimmer shafts 20 (FIG. 7).

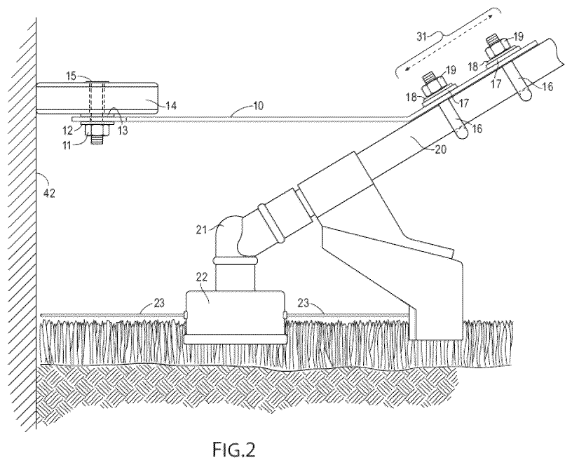

The “U-bolt” 16 fastener could be replaced by a fabricated attachment device 50 which is permanently attached to the short section 10C of the support arm 10. There are many different forms that the attachment device 50 could take. Attachment device 50 could take the form of a rectangular sleeve whereby the string trimmer shaft 20 is slotted into a hole that traverses the length of the attachment device 50. It (50) could also take the form of a saddle that is bolted onto the string trimmer shaft. As with the clamping apparatus (16-19), the attachment device 50 is designed to allow for adjustment of support arm 10 along 31 (FIG. 2) the string trimmer shaft 20 to allow for spacing between support arm 10 and string trimmer gear case 21 as well as positioning of the wheel 14 to provide proper spacing of the rotating string 23 diameter.

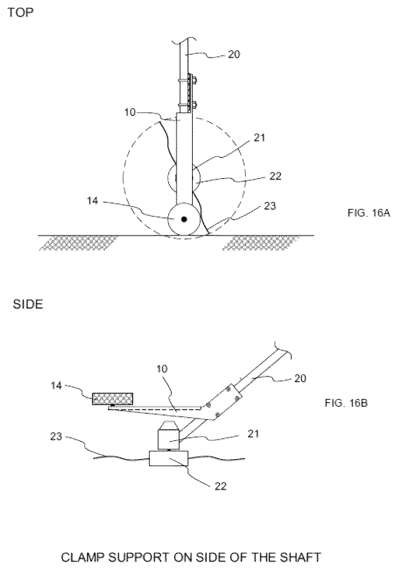

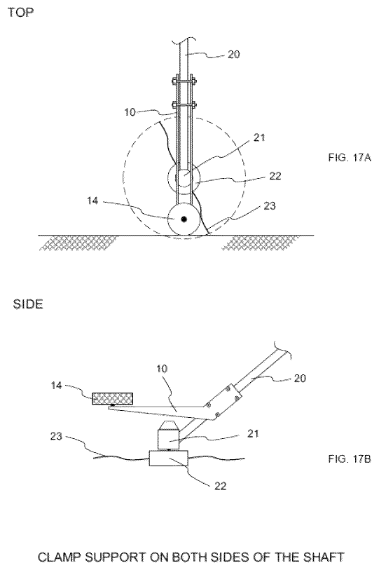

FIGS. 1 through 4 show the show the support arm 10 position on top of the string trimmer shaft 20. However, the support arm 10 can also be attached to positions other than the top of the string trimmer shaft 20 such as the side or bottom (FIG. 16) so long as the wheel 14 end of the support arm 10 positions the wheel 14, parallel or near parallel to the plane of the string trimmer sting 23 rotation. Additionally, the angled support arm 10 can be configured so that it attaches on both sides (serving as its own clamping device) of the string trimmer shaft 20 (FIG. 17) so long as the wheel 14 end of the support arm 10 positions the wheel 14, parallel or near parallel to the plane of the string trimmer sting 23 rotation.

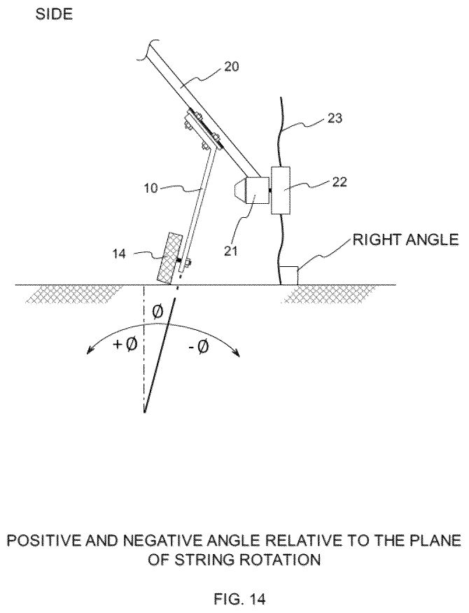

While the angled support arm 10 is shown in a parallel plane as the rotation of the string trimmer string 23 rotation (FIG. 2), it can also have an offset from the string trimmer string 23 rotation plane as shown in FIG. 14.

The angled support arm 10 is also configured to secure and position a wheel assembly. The wheel assembly consists of a wheel 14, and wheel axle 15, axle washer 13, axle nut washer 12 and a axle nut 11. Wheel axle 15 can be attached to the support arm 10 through either a single or multiple fixed holes or support arm slot 10A in the support arm 10 to provide for further adjustment as desired. The wheel 14 is meant to be free spinning by the means of a collared wheel axle 15. The wheel 14 can be placed on either side of support arm 10, on top (shown) or on the opposite side of the support arm 10 closer to the string trimmer gear case 21. While a threaded axle nut 11 is shown, this can be replaced with either a wing nut, knob, rotating knob, lever style wing nut, self-locking nut, double nutting, cap nut, etc.

The wheel 14 can be of various diameters and thicknesses. The nominal diameter of the wheel 14 is five inches with a range of four to six inches. The nominal thickness of the wheel 14 is one and a quarter inches with a range of one to two inches. It should be noted that the wheel 14 is not limited to these ranges for diameter and thickness.

The wheel 14 can be solid, spoked or other wheel configuration. The wheel 14 tread can be smooth or various knobbiness and tread configurations as desired. The preferred material for wheel 14 is lightweight plastic; however, other materials and combination of materials such as rubber, metal, metal alloys, foam can be used to function as a wheel 14.

The axle washer 13 is configured to provide appropriate tolerances and support between the wheel axle 15 and the support arm 10 to allow the wheel 14 to spin freely. The axle nut washer 12 is configured to appropriate support between the support arm 10 and the axle nut 11.

While the preferred material of construction for the wheel axle 15, the axle washer 13, the axle nut washer 12, the axle nut 11, the clamping apparatus bracket (“U-bolt”) 16, the clamping apparatus plate 17, the clamping apparatus washers 18 and the clamping apparatus nuts 19 is steel, other metals, metal alloys, plastics and other sufficiently rigid materials could be used.

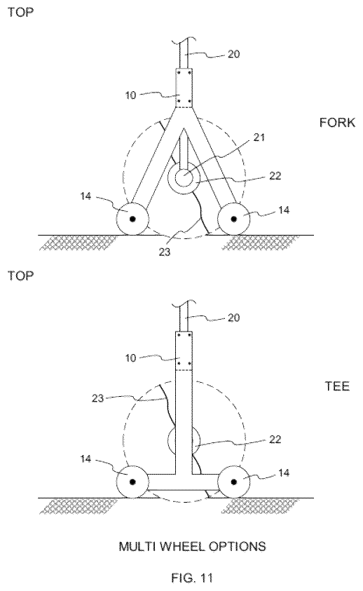

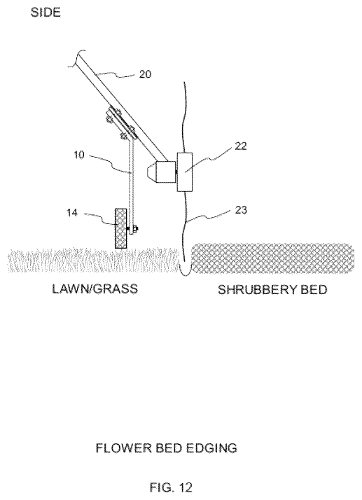

The preferred embodiments of the invention utilize a one wheel 14 configuration. (FIGS. 1 through 4). Other embodiments of the invention may utilize multiple wheel configurations (FIG. 11). Multiple wheel embodiments could be configured with forked or tee shaped support arms 10.

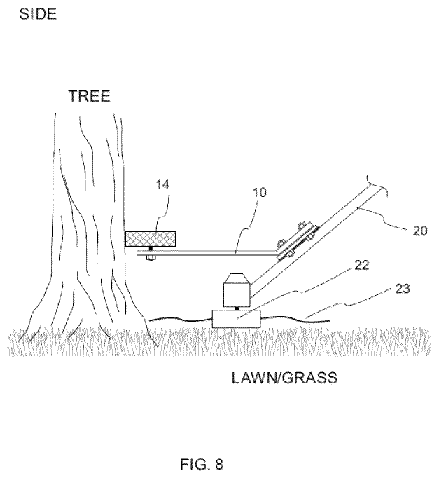

FIG. 2 shows a side view perspective of one embodiment of the invention in a horizontal (parallel to the ground) application using the invention to properly distance the rotation of the string trimmer string 23 from a perpendicular surface 42. Perpendicular surfaces 42 may include fences, posts, trees (FIG. 8), walls and other rigid, soft, brittle, abrasive surfaces.

Additionally, FIG. 2 shows how the clamping device can allow for travel 31 of the support arm 10 along the string trimmer shaft 20 to allow the string trimmer support to be adjusted as desired to position the wheel 14 relative to the proper clearance to the rotating string trimmer string 23.

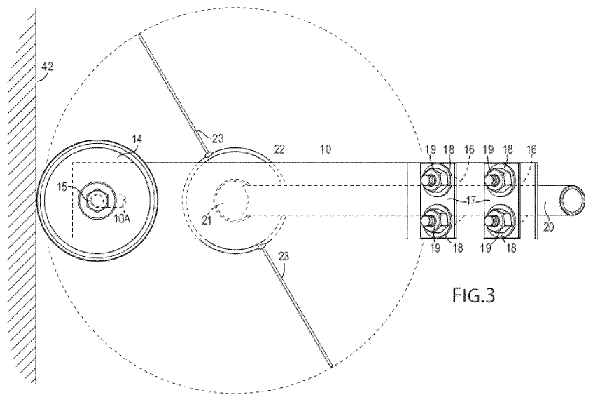

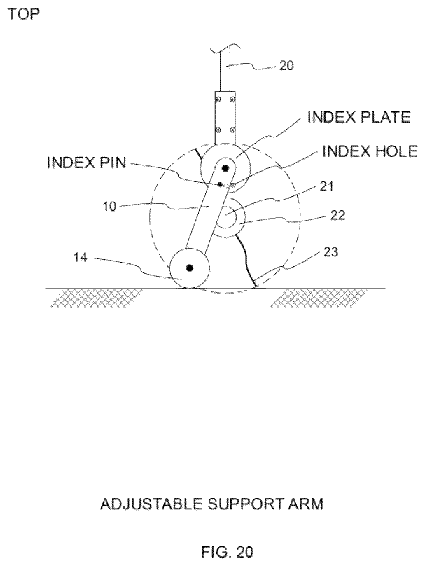

As FIG. 3 depicts a top or front view perspective of the device and that the string trimmer support is in line with the string trimmer shaft 20 including the support arm 10, the support arm 10 could be configured with an offset (FIG. 10) so that the wheel 14 either leads or trails the symmetry plane of the string trimmer shaft 20, string trimmer gear case 21 and the string trimmer string head 22. This angle could be adjustable by means of an index plate with index pin (FIG. 20).

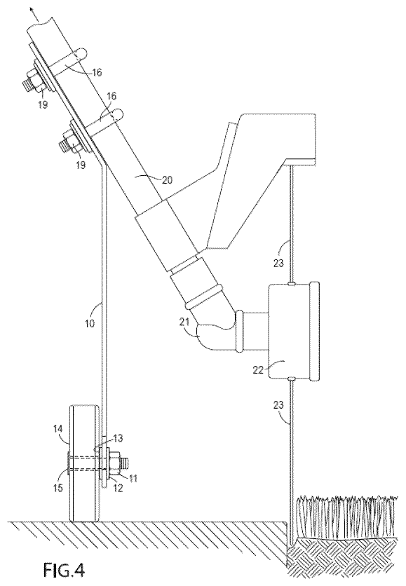

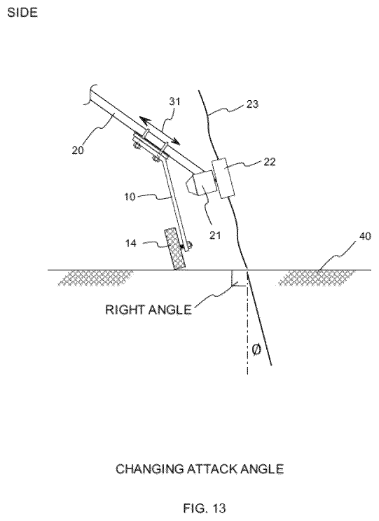

FIG. 4 illustrates a side view perspective of one example of a string trimmer support in a vertical (perpendicular to surface) edging application and as the clamping device allows for adjustment along 31 the string trimmer shaft 20, the device can be adjusted in order to change the planer rotation of the string from perpendicular to the solid surface 40 either a slightly negative or positive angle from perpendicular (FIG. 13).

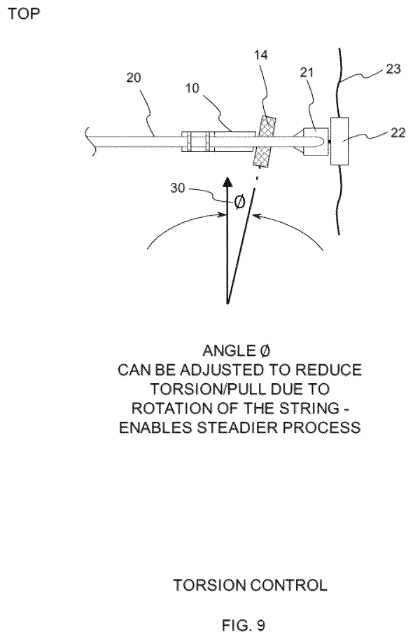

FIGS. 2, 3 and 4 depict the device wheel 14 configuration in a parallel plane to the string trimmer string 23 rotation plane, the device can be adjusted to mis-align the functional plane of the wheel 14 to the plane of the rotating string trimmer string 23 (FIG. 9) thereby imposing a resistance force to the forces imposed by the string trimmer string 23 rotation and string tip impact with surfaces. This offers torsional control (rotational forces about the string trimmer shaft 20).

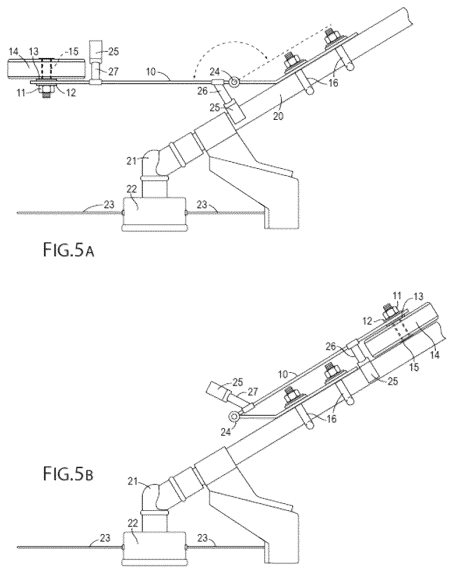

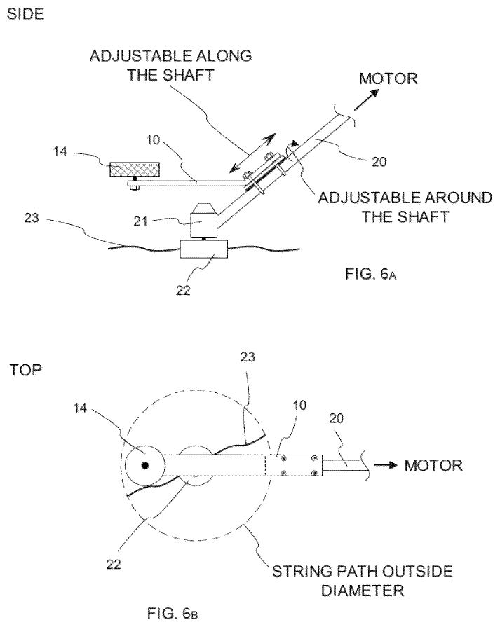

FIG. 5A depicts a side view of string trimmer support in an extended/functional manner showing further embodiments that could be integrated into the design include but are not limited to a support arm hinge 24 in the support arm 10 to allow the wheel 14 end to rotate from its functional (extended) position to a location along the string trimmer shaft 20 out of the way if clearance is needed above the string trimmer gear case 21 for certain trimming needs. A clipping system consisting of a string trimmer shaft clip 25 and an extended clip bracket 27 are used to maintain the string trimmer support in the functional position. While a clipping system is detailed, other securing devices could be used. The string trimmer shaft clip 25 is configured to correspond to the string trimmer shaft 23 diameter. The extended clip bracket 27 can be of various lengths.

FIG. 5B depicts a side view of string trimmer support in a retracted manner showing further embodiments that could be integrated into the design include but are not limited to a support arm hinge 24 in the support arm 10 to allow the wheel 14 end to rotate from its functional (extended) position to a retracted location along the string trimmer shaft 20 out of the way if clearance is needed above the string trimmer gear case 21 for certain trimming needs. A clipping system consisting of a string trimmer shaft clip 25 and a retracted clip bracket 26 are used to maintain the string trimmer support in the retracted position. While a clipping system is shown other securing devices could be used. The string trimmer shaft clip 25 is configured to correspond to the string trimmer shaft 23 diameter. The retracted clip bracket 26 can be of various lengths.

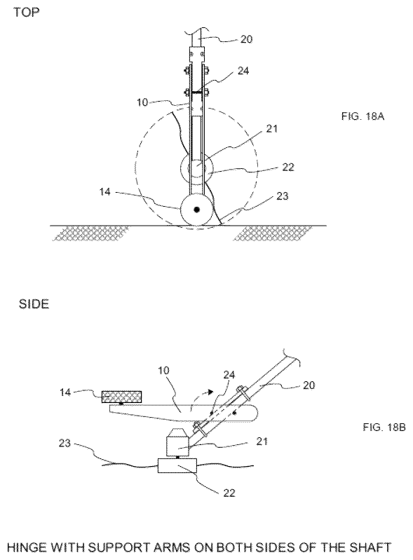

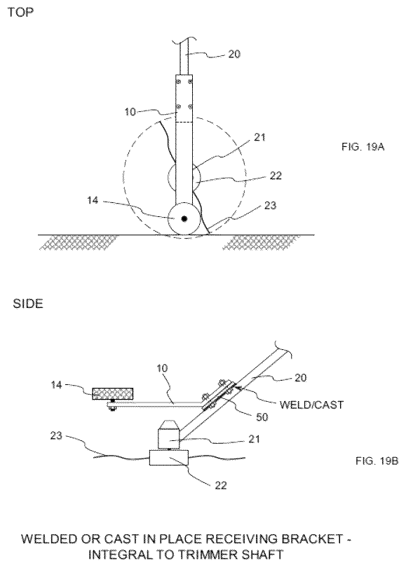

While FIGS. 5A & 5B depicts a side view of string trimmer support retraction option with the clamping device and support arm hinge 24 on the top of the string trimmer shaft 20, other support arm configurations can be used such as a support arm clamped to either side of the string trimmer shaft 20, as shown in FIG. 18, the hinging 24 mechanism could be configured in that arrangement to allow for retracting as well. A spring or springs could be used to maintain retracted and extended positions.

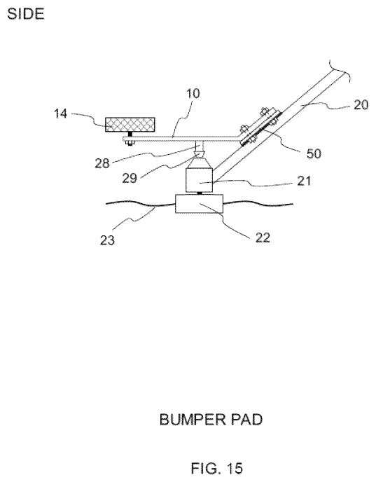

FIG. 15 depicts an example of how the support arm 10 can also be configured to attach a support arm bumper pad bracket 28 connected to a support arm bumper pad 29 between support arm 10 and string trimmer gear case 21 to maintain a set distance between the support arm 10 and the string trimmer gear case 21. The support arm bumper pad bracket 28 can be of various lengths and adjustable.

While preferred material of construction for the string trimmer shaft clip 25, the retracted clip bracket 26, the extended clip bracket 27, the support arm bumper pad bracket 28 and the support arm bumper pad 29 is steel; other metals, metal alloys, plastics and other sufficiently rigid materials could be used.

Suggested classifications for this invention include:
A01G 3/06: Hand-held edge trimmers or shears for lawns
A01D 34/84: Mowers for edges of lawns or fields, e.g. for mowing close to trees or walls
A01D 34/416: Flexible line cutters

The invention claimed is:

1. A string trimmer support device comprising an angled support arm, a clamping apparatus located at the proximal end of the angled support arm to the string trimmer, and a wheel that is affixed to the distal end of the angled support arm, where said angled support arm is attached to the string trimmer by said clamping apparatus, where said angled support arm has two sections, the proximal end that holds the clamping apparatus is four to ten inches in length, the distal end that holds the wheel is ten to eighteen inches in length with the angle between the two sections of the angled support arm being 140 to 170 degrees, where said angled support arms comprises rectangular plate of aluminum, metal alloy, or plastic; where said clamping apparatus comprises U-bolt clamps; where said wheel is constructed of plastic and is four to six inches in diameter and one to two inches thick; and where said device is attached to the string trimmer shaft to position said wheel parallel to the rotating string of the string trimmer.

2. The string trimmer support device of claim 1, where said clamping apparatus comprises a toggle clamp, seat post clamp, saddle clamp, telescoping tube clamp, split pipe clamp, or set screw clamps.

3. The string trimmer support device of claim 1, where said wheel is constructed of rubber, metal, metal alloys, or foam.

4. A string trimmer support device comprising a clamping apparatus, a support arm, support arm hinge, and wheel, where said clamping support arm is attached to the string trimmer shaft at an angle so as to position said wheel parallel to the rotating string of the string trimmer; where said support arm hinge allows positioning of the support arm and wheel alongside the string trimmer shaft, where said clamping apparatus comprises U-bolt clamps, where said support arm comprises a rectangular plate, square tubing, rectangular tubing, round tubing, or oval tubing, and said support arm is aluminum, metal alloy, or plastic, where said wheel is affixed to the distal end of said support arm and is constructed of plastic.

5. The string trimmer support device of claim 4, where said clamping apparatus comprises a toggle clamp, seat post clamp, saddle clamp, telescoping tube clamp, split pipe clamp, or set screw clamps.

6. The string trimmer support device of claim 4, where said wheel is constructed of rubber, metal, metal alloys, or foam.
